(19) United States
(12) Patent Application Publication
(10) Pub. No.: US 2014/0214929 A1
(43) Pub. Date: Jul. 31, 2014

(54) METHOD AND APPARATUS FOR SHARING ELECTRONIC CONTENT

(71) Applicants: SONY CORPORATION, Tokyo (JP); SONY NETWORK ENTERTAINMENT INTERNATIONAL LLC, Los Angeles, CA (US)

(72) Inventors: Thomas Dawson, San Diego, CA (US); Charles McCoy, San Diego, CA (US); James R. Milne, San Diego, CA (US); True Xiong, San Diego, CA (US); Trisha Yasuhara, San Diego, CA (US)

(73) Assignees: SONY NETWORK ENTERTAINMENT INTERNATIONAL LLC, Los Angeles, CA (US); SONY CORPORATION, Tokyo (JP)

(21) Appl. No.: 13/749,858

(22) Filed: Jan. 25, 2013

(51) Int. Cl. H04L 29/08

(52) U.S. Cl. CPC H04L 67/02
USPC 709/204

(57) ABSTRACT

Disclosed is a method and system for sharing content between a plurality of electronic devices including identifying an event and detecting one or more electronic devices based on the identified event. Electronic content is obtained from one or more of the electronic devices related to the event and provided to one or more output devices based on a comparison.

### BACKGROUND

1. Field of the Invention

This invention relates generally to obtaining and sharing electronic content between users wishing to access the electronic content. More particularly, the present invention relates to identifying electronic devices in a particular area and providing an interface between the identified devices so that content and processing functions may be shared between devices.

2. Background Discussion

Sharing electronic content has become a popular way for users of electronic devices to interact. Many social networking websites and services permit users to share content of interest. While social networking provides a forum to share electronic content, it would be an advancement in the art to provide an efficient and user-friendly system for a user to obtain and share electronic content.

### SUMMARY

Embodiments of the present invention involve a system and method to share live event data through the use of an application and a network.

Accordingly, one embodiment of the present invention is directed to a method and system for sharing content between a plurality of electronic devices including identifying an event and detecting one or more electronic devices based on the identified event. Electronic content is obtained from one or more of the electronic devices related to the event and provided to one or more output devices based on a comparison.

In another embodiment, the one or more output modules are located remotely from the one or more electronic devices.

In yet another embodiment, a positioning system is utilized to detect that one or more electronic devices that are within a predetermined geographical distance from the event. A longitude coordinate and a latitude coordinate associated with each electronic device is identified.

In another embodiment, a perspective viewing location of an electronic device that is obtaining content is determined.

In yet another embodiment, the electronic content is in a 3D format.

In another embodiment, the electronic content is in a high definition format.

In yet another embodiment, electronic content is provided from the electronic devices to the output devices as a data stream. The electronic content can be stored.

In another embodiment, the electronic content includes advertisement data. The advertisement data based can be selected based on a geographical location of the electronic device receiving the advertisement data.

In yet another embodiment, capabilities of the detected devices are identified.

In another embodiment, the method includes identifying a location of one or more second electronic devices; generating a notification related to the event; and transmitting the notification to one or more of the second electronic devices.

In another embodiment, the method includes modifying the obtaining step based on the comparison.

In yet another embodiment, the electronic devices that are within a predetermined geographical distance from the event are fixed cameras.

In another embodiment, the method includes associating a user-applied tag to content.

In yet another embodiment, the method includes identifying one or more available processing modules, the available processing modules being able to process electronic content; providing electronic content to selected one or more available processing modules; processing the electronic content at the selected one or more available processing modules; and providing the processed electronic content to an output device.

In another embodiment, the method includes providing a listing of electronic devices that are providing data related to an event to a user device; receiving a selection of an electronic device from the user device; and providing content to the user device based on the selection.

In yet another embodiment, the listing of electronic devices includes functionality of each listed electronic device.

In another embodiment, the electronic devices include cameras.

In yet another embodiment, the method includes restricting electronic content provided by one of the electronic devices based on a user of the electronic device refusing to provide electronic content to an output device.

In another embodiment, the method includes providing a listing of electronic devices that are providing data related to an event to a user device; receiving a selection of a media format from the user device; and providing content to the user device based on the selection.

In yet another embodiment, the method includes providing a plurality of content to the user device in a plurality of formats simultaneously.

In another embodiment, the electronic devices include audio output devices.

In yet another embodiment, the method includes the electronic content is text content.

In another embodiment, the electronic content includes video content, and/or image content and/or audio content.

In yet another embodiment of the method, the identifying an event further includes identifying a plurality of events within a predefined geographical region; organizing the plurality of events within the predefined geographical region into one or more clusters; and labeling the one or more clusters.

In another embodiment of the method, the identifying an event further includes identifying a plurality of events within a predefined time period; organizing the plurality of events within the predefined time period into one or more clusters; and labeling the one or more clusters.

### BRIEF DESCRIPTION OF THE DRAWINGS

To the accomplishment of the foregoing and related ends, certain illustrative embodiments of the invention are described herein in connection with the following description and the annexed drawings. These embodiments are indicative, however, of but a few of the various ways in which the principles of the invention may be employed and the present invention is intended to include all such aspects and their equivalents. Other advantages, embodiments and novel features of the invention may become apparent from the following description of the invention when considered in conjunction with the drawings. The following description, given by way of example, but not intended to limit the invention solely to the specific embodiments described, may best be understood in conjunction with the accompanying drawings, in which:

FIG. 1 shows a diagram of a network environment that supports embodiments of the present invention.

FIG. 2 shows diagram of modules and a network according to another embodiment of the present invention.

FIG. 3 shows a series of steps to implement an embodiment of the present invention.

FIG. 4 shows a series of steps to implement another embodiment of the present invention.

FIG. 5 shows a series of steps to change a source of content, according to an embodiment of the present invention.

FIG. 6 shows a series of steps to share processing functions between a plurality of devices.

### DETAILED DESCRIPTION

It is noted that in this disclosure and particularly in the claims and/or paragraphs, terms such as “comprises,” “comprised,” “comprising,” and the like can have the meaning attributed to it in U.S. patent law; that is, they can mean “includes,” “included,” “including,” “including, but not limited to” and the like, and allow for elements not explicitly recited. Terms such as “consisting essentially of” and “consists essentially of” have the meaning ascribed to them in U.S. patent law; that is, they allow for elements not explicitly recited, but exclude elements that are found in the prior art or that affect a basic or novel characteristic of the invention. These and other embodiments are disclosed or are apparent from and encompassed by, the following description. As used in this application, the terms “component” and “system” are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

Furthermore, the detailed description describes various embodiments of the present invention for illustration purposes and embodiments of the present invention include the methods described and may be implemented using one or more apparatus, such as processing apparatus coupled to electronic media. Embodiments of the present invention may be stored on an electronic media (electronic memory, RAM, ROM, EEPROM) or programmed as computer code (e.g., source code, object code or any suitable programming language) to be executed by one or more processors operating in conjunction with one or more electronic storage media. This electronic storage media may include, for example a non-transitory electronic storage medium/media such as a register, or other electronic repository or electronic storage location for data that is capable of storing data represented in electronic form, such as bits, bytes, kilobytes, waveforms, electronic signals, digital format and other data types, formats and forms of data.

Embodiments of the present invention may be implemented using one or more processing devices, or processing modules. The processing devices, or modules, may be coupled such that portions of the processing and/or data manipulation may be performed at one or more processing devices and shared or transmitted between a plurality of processing devices.

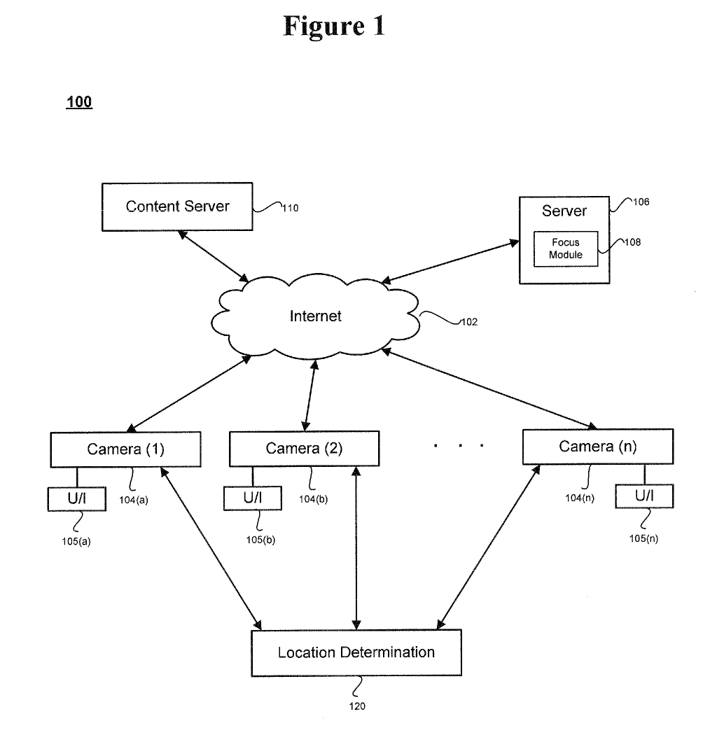

FIG. 1 illustrates an example of a system 100 that supports embodiments of the present invention. The system 100 shown in FIG. 1 includes a network 102, one or more electronic media source devices (cameras) 104(a), 104(b) . . . 104(n) (where “n” is any suitable number), a server module 106, a content server 110 and a location determination module 120, that is used to determine the location of the device(s) 104. The location determination module 120 may utilize GPS functionality, cell tower triangulation, monitoring of wi-fi or other local radio signals, looking up an address, zip-code, IP address, or other identifying information to accurately identify the geographic location of devices(s) 104.

The network 102 is, for example, any combination of linked computers, or processing devices, adapted to transfer and process data. The network 102 may be private Internet Protocol (IP) networks, as well as public IP networks, such as the Internet that can utilize World Wide Web (www) browsing functionality. An example of a wired network is a network that uses communication buses and MODEMS, or DSL lines, or a local area network (LAN) or a wide area network (WAN) to transmit and receive data between terminals. An example of a wireless network is a wireless LAN. Global System for Mobile Communication (GSM) is another example of a wireless network. The GSM network is divided into three major systems which are the switching system, the base station system, and the operation and support system (GSM). Also, IEEE 802.11 (Wi-Fi) is a commonly used wireless network in computer systems, which enables connection to the Internet or other machines that have Wi-Fi functionality. Wi-Fi networks broadcast radio waves that can be picked up by Wi-Fi receivers that are attached to different computers.

The media source electronic devices, modules, or facilities, or units (also referred to as media source, and/or cameras) 104(a), 104(b) . . . 104(n) (where “n” is any suitable number), (generally referred to as 104, herein) typically have electronic data acquisition capability, such as obtaining, recording, reproducing and processing image data and/or audio data and/or a combination of image data and audio data. The media source devices 104 may be, for example, network cameras that can receive and transmit data via a network (102). The media source devices 104 may also be embodied as a Smartphone, IPTV (Internet Protocol Television) devices or other handheld device that can acquire and transmit image/audio data. The media source devices 104 may be electronic devices with processing capabilities and memory and an output displays, such as, laptop computers, desktop computers, cell phone, personal digital assistant (PDA), wireless handheld device, and the like. The media source devices 104 may be capable of processing and storing and displaying data themselves or merely capable of accessing processed and stored data from another location (i.e., both thin and fat terminals) and displaying the accessed or retrieved data. The media source devices 104 may also be a source of still images related to an event. The media source devices 104 are in bi-directional communication with network 102 as shown by the associated arrows. The bi-directional communication may be, for example, a serial bus such as IEEE 1394, or other wire or wireless transmission medium. The media source devices 104 are each coupled to an associated user interface module 105(a), 105(b) and 105(n), respectively. The user interface module (generally 105) is used to present media about an event to a user. The user interface device 105 is, for example, a display screen and may also include a keyboard, mouse, track ball or other input mechanism. The user interface 105 may also include a speaker to provide audio data to a user.

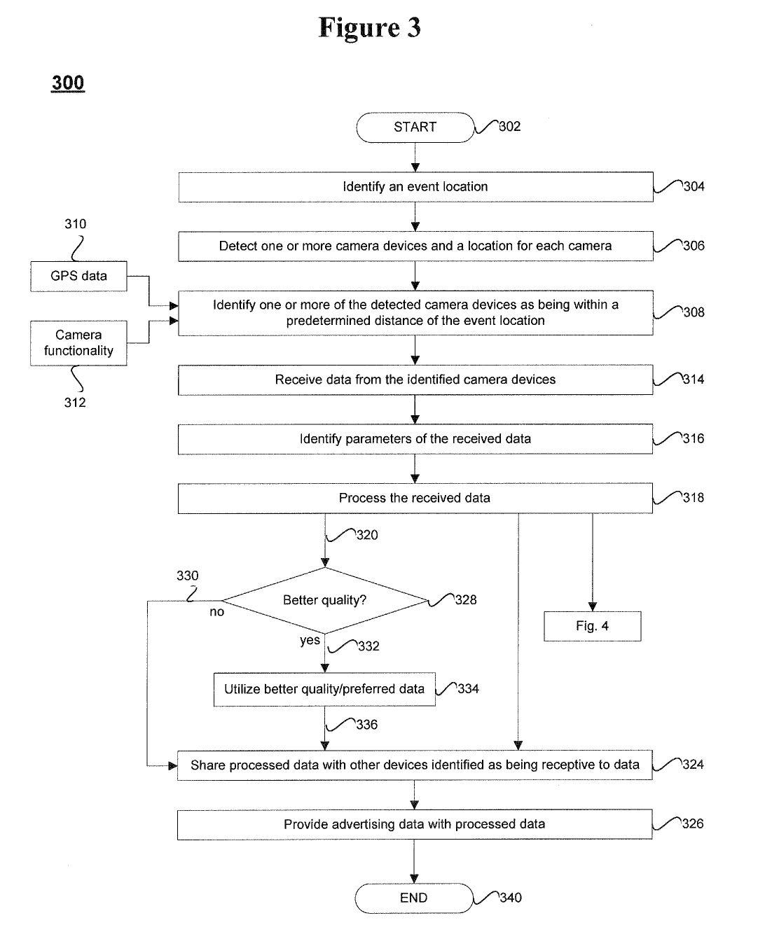

The server module, or facility, or unit, 106 is typically one or more processors with associated memory, such as computers, or other processing devices such as a desktop computer, laptop computer, personal digital assistant (PDA), wireless handheld device, cellular telephone, or the like. The server module 106 is capable of processing and storing data or merely capable of accessing processed and stored data from another location (i.e., both thin and fat terminals). The server 106 includes electronic storage locations, such as RAM, ROM, EEPROM, registers and any suitable electronic storage medium that can store electronic data. The storage functionality of server 106 may be used to store algorithms, such as the algorithms described herein in relation to FIGS. 3-6. Storage may be any suitable electronic storage, such as RAM, ROM, EEPROM, or other storage medium, or cloud-based storage using local or remote storage via a network, such as storage at a remote server.

The server module 106 includes a focus module 108. The focus module 108 is used to process and compare image data received from the camera devices 104.

The server module 106 is in bi-directional communication with network 102 as shown by the arrow. The bi-directional communication may be, for example, a serial bus such as IEEE 1394, or other wire or wireless transmission medium.

The content server 110 is a or facility, or unit, that typically includes one or more processors with associated memory, such as computers, or other processing devices such as a desktop computer, laptop computer, personal digital assistant (PDA), wireless handheld device, cellular telephone, or the like. The content server module 110 is capable of processing and storing data or merely capable of accessing processed and stored data from another location (i.e., both thin and fat terminals). The content server module 110 is used to store electronic content, such as audio data, image data and/or a combination thereof. The content server 110 may also access other storage databases, such as IMDB (Internet Movie Database) database. The content server 110 is in bi-directional communication with network 102 as shown by the associated arrow. The bi-directional communication may be, for example, a serial bus such as IEEE 1394, or other wire or wireless transmission medium.

The location determination module (also referred to as GPS module herein) 120 is used to identify a location of camera devices 104. The location determination module 120 is typically to used to identify longitude and latitude coordinates of each camera 104. The location determination module 120 can provide location data of each camera 104 to server 106. Server 106 can use the camera location data from location determination module 120 to correlate a camera's proximity to an event. The location determination module 120 is in bi-directional communication with network 102 as shown by the associated arrow. The bi-directional communication may be, for example, a serial bus such as IEEE 1394, or other wire or wireless transmission medium.

The media source devices (cameras) 104, server module 106, and content server 110 may be communication appliances, or user locations, or subscriber devices.

Embodiments of the present invention may be implemented using one or more processing devices, or processing modules. The processing devices, or modules, may be coupled such that portions of the processing and/or data manipulation may be performed at one or more processing devices and shared or transmitted between a plurality of processing devices.

The media source (camera) devices 104 may be IPTV (Internet Protocol Television) devices, smart phones or other device capable of obtaining image data, audio data or a combination thereof and processing or reproducing or transmitting the acquired electronic content. The media source devices 104 have memory and processing capabilities. Indeed, the devices 104 may also access one or more computer readable storage media such as RAM-based storage (e.g., a chip implementing dynamic random access memory (DRAM) or flash memory or disk-based-storage. Software code implementing present logic executable by the media source device 104 may also be stored on one of the memories of the media source device 104.

It is an embodiment of the present invention that the media source devices 104 are IPTV devices. An IPTV device can access a vast pool of content provided by numerous content providers. The IPTV device may also be used to control further distribution of content that has been provided by a third party to the IPTV device so that unauthorized access is prevented. Typically, IPTV is controlled by a single input device and has a single display device. Indeed, there may be a plurality of sources providing content to the media source devices 104, which may correspond to an event. When users are accessing the content it is possible to compare various sources for a particular event. The popularity of events that users are choosing to view and the duration of the viewing may be used to determine a preferred source of the content being accessed by a user. Thus, one way to identify an event or interest to a user is to use the proximity of the event venue to the user's location. For example, a user at a baseball game may be interested in viewing media content from the baseball game event. Other users in the same town, but not at the ballpark are fairly likely to be interested in the baseball game too. Users in neighboring towns may be assumed to be more interested in that ball game than in a ball game in a far away state.

Furthermore, information known about a user's preferences could also be used to identify those events that are likely to be of interest to a user. For example, it could be known that some users are interested in sports while other users are not interested in sports, but are interested in cooking.

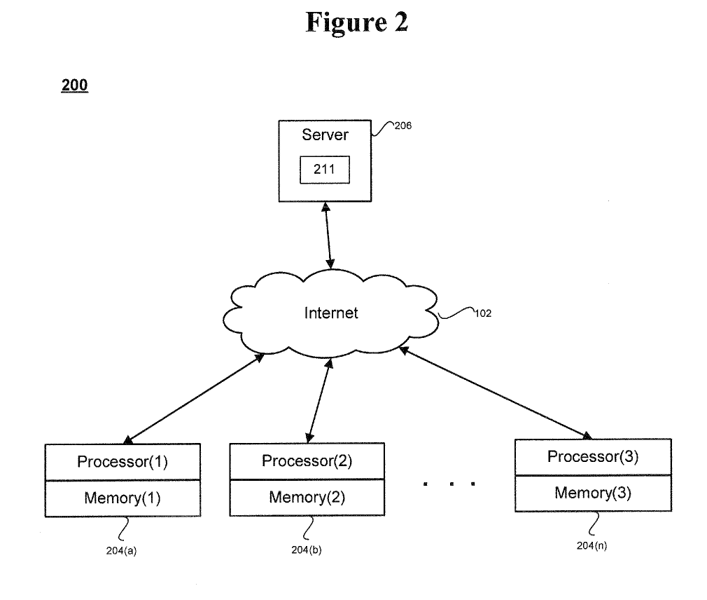

FIG. 2 shows diagram 200 that include modules and a network according to another embodiment of the present invention. As shown in FIG. 2 the system 200 includes network 102 one or more electronic devices 204(a), 204(b) . . . 204(n) (where “n” is any suitable number) and a server module 206.

The network 102 is, similar to FIG. 1, any combination of linked computers, or processing devices, adapted to transfer and process data. The network 102 may be private Internet Protocol (IP) networks, as well as public IP networks, such as the Internet that can utilize World Wide Web (www) browsing functionality. An example of a wired network is a network that uses communication buses and MODEMS, or DSL lines, or a local area network (LAN) or a wide area network (WAN) to transmit and receive data between terminals. An example of a wireless network is a wireless LAN. Global System for Mobile Communication (GSM) is another example of a wireless network. The GSM network is divided into three major systems which are the switching system, the base station system, and the operation and support system (GSM). Also, IEEE 802.11 (Wi-Fi) is a commonly used wireless network in computer systems, which enables connection to the Internet or other machines that have Wi-Fi functionality. Wi-Fi networks broadcast radio waves that can be picked up by Wi-Fi receivers that are attached to different computers.

The electronic devices, modules, or facilities, or units 204(a), 204(b) . . . 204(n) (where “n” is any suitable number), (generally referred to as 204, herein) typically have electronic data acquisition capability, such as obtaining, recording, reproducing and processing image data and/or audio data and/or a combination of image data and audio data. The electronic device 204 may be, for example, network cameras that can receive and transmit data via a network (102). The electronic devices 204 may also be embodied as a Smartphone, IPTV (Internet Protocol Television) devices or other handheld device that can acquire and transmit image/audio data. The electronic devices 204 include a processing module and a memory module. The electronic devices 204 may also include an output display. Examples of electronic devices 204 include laptop computers, desktop computers, cell phone, personal digital assistant (PDA), wireless handheld device, and the like.

The electronic devices 204 may be capable of processing and storing and displaying data themselves or merely capable of accessing processed and stored data from another location (i.e., both thin and fat terminals) and displaying the accessed or retrieved data. The electronic devices 204 are in bi-directional communication with network 102 as shown by the associated arrows. The bi-directional communication may be, for example, a serial bus such as IEEE 1394, or other wire or wireless transmission medium.

The server module, or facility, or unit, 206 is typically one or more processors with associated memory, such as computers, or other processing devices such as a desktop computer, laptop computer, personal digital assistant (PDA), wireless handheld device, cellular telephone, or the like. The server module 206 is capable of processing and storing data or merely capable of accessing processed and stored data from another location (i.e., both thin and fat terminals). The server 206 includes electronic storage locations, such as RAM, ROM, EEPROM, registers and any suitable electronic storage medium that can store electronic data. The storage functionality of server 206 may be used to store algorithms, such as the algorithms described herein in relation to FIGS. 3-6. Storage may be any suitable electronic storage, such as RAM, ROM, EEPROM, or other storage medium, or cloud-based storage using local or remote storage via a network, such as storage at a remote server.

The server module 206 includes a directing module 211. The directing module 211 is used to store and execute program code to direct processing functionality for the electronic devices 204. For example, one electronic device 204(a) may acquire image data that requires processing. The electronic device 204(a) may not be able to process the data as efficiently as another electronic device (e.g., 204(b)) so the electronic device 204(a) may use directing module 211 to send data to electronic device 204(b) for processing. The processed data from device 204(b) would then be returned to device 204(a).

FIG. 3 illustrates an example of a series of steps 300 for an embodiment of the present invention. The series of steps 300 may be stored on a non-transitory computer readable medium or media (e.g., RAM, ROM, EEPRPOM, DRAM or other memory, electronic storage device or registry) and may be executed by a processor or plurality of processors. The storage medium may be resident on the device (local) or accessed from a remote device (remote). The steps 300 are typically executed by a processor having adequate speed and processing capabilities. The execution may be at the client device and/or an associated server device. The steps 300 may be computer code or other program code (e.g., source code) that may be compiled into object code.

The code, stored on a medium and/or accessed, is a module. The steps 300 may be stored on any one or more suitable modules described in relation to FIG. 1 and FIG. 2 herein.

The process executed by the steps shown in FIG. 3 begins with start step 302. An event location is identified, as shown in step 304. This event location step may include, for example, identifying a location or venue of an event, such as a concert, play, fair, or other activity. The event location may be determined using longitude and latitude coordinates, GPS, print advertisement, web site notification, email blast, or other notification mechanism.

One or more camera devices and a location for the camera device are detected, as shown in step 306. The proximity, or relative location of a camera to the event, is identified, as shown in step 308. This identification step may use GPS data, step 310, to determine how close a camera device is to an event. Furthermore, the available camera device functionality may be identified, as shown in step 312. The camera device functionality may be accessed once a particular camera is identified as being within a predetermined distance of the event location. Thus, one or more camera devices, and the functions (memory, storage, processing, transmitting, focus and other camera functions) of the camera are determined.

The identified camera devices are used to provide data, such as video data, audio data, image data or other electronic data to a data collection source (e.g., a memory location as described herein, for example, at a server, as described in FIG. 1 and FIG. 2 herein), as shown in step 314. This data, obtained from the camera devices is usually obtained from the event, which was identified.

The data is analyzed and parameters of the data received from each camera device are identified. These parameters include, for example, position of the camera device when the data was received, degree of noise or other interference present, quality of the electronic data and other aspects of the obtained data, as shown in step 316. There may be multiple cameras at a particular event, such as a live stage performance, streaming content from a different perspective or different location. For example, one camera may be being held by a user in a stadium seat, a second camera may be held by a user closer to the stage and a third camera may be held by a user backstage. Each camera will be providing content for the event from their vantage or viewing point.

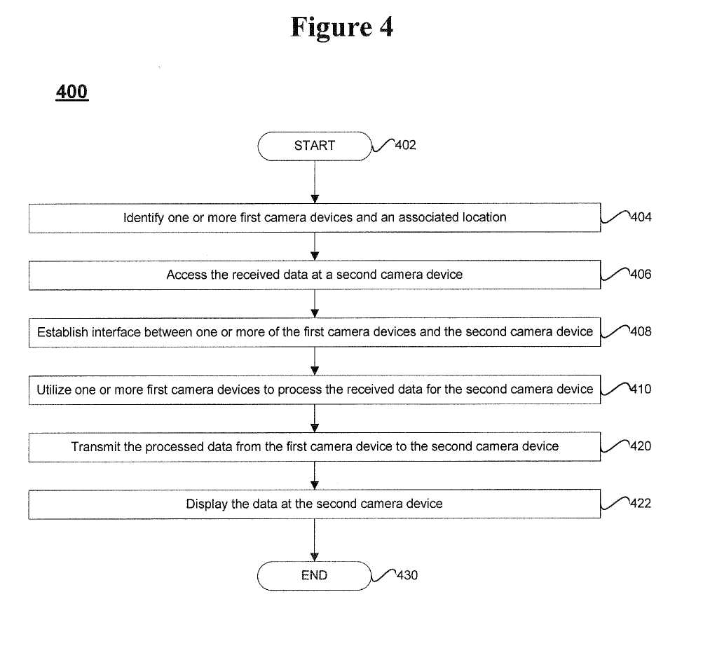

The data that is obtained is then processed, as shown in step 318. This processing may include, filtering, storing, manipulating, comparing data from various camera devices that are sending electronic content from the same event, and other data operations, based on the condition of the data that is received. The processing may be used to determine a better quality content, or more desirable focus or other determination about the received content. The step of processing the data may lead to a subroutine, as shown in FIG. 4. Alternatively, the processed data may be shared with other devices that are receptive to the data, as shown in step 324.

A decision is made whether regarding the quality of the content, as shown in decision step 328, reach via line 320. This determination about the quality of the content is made after the data has been processed.

If some of the content is deemed to be of better quality in step 328, that content or data may be used as a representation of the event, as shown in step 334, reached via “yes” line 332.

If there is no better quality content, “no” line 330 shows that the processed data, or content is shared with other devices, as shown in step 324. The content data may be provided to other devices, as deemed appropriate, as having necessary storage/processing/display capabilities. The other devices may include any device that can receive the content. The device may store the content, display the content or transmit the content to another location.

Alternatively, step 324 may be reached from step 334, via line 336. In either embodiment, the highest quality content is used to represent the event.

The content data, which is provided to other devices, may also include advertising data, as shown in step 326. The advertisement data may include advertisement content that is related to the content being displayed. For example, the event may be a concert put on by an artist and the advertisement may be advertising a new album by the artist giving the performance. Alternatively, the advertising data may be non-specific advertisements that are provided with the content.

The process 300 ends, as shown by end step 340.

FIG. 4 shows a series of steps 400 to implement another embodiment of the present invention. The series of steps 400 may be stored on a non-transitory computer readable medium or media (e.g., RAM, ROM, EEPRPOM, DRAM or other memory, electronic storage device or registry) and may be executed by a processor or plurality of processors. The storage medium may be resident on the device (local) or accessed from a remote device (remote). The steps 400 are typically executed by a processor having adequate speed and processing capabilities. The execution may be at the client device and/or an associated server device. The steps 400 may be computer code or other program code (e.g., source code) that may be compiled into object code. The code, stored on a medium and/or accessed, is a module. The steps 400 may be stored on any one or more suitable modules described in relation to FIG. 1 and FIG. 2 herein.

The process 400 may be a subroutine that can be used in conjunction with the process 300 in FIG. 3 or may be executed as a stand-alone process. Also, the process 400 may be used with the modules shown in FIG. 2. The process 400 may be executed by a processor and begins with start step 402.

One or more first camera devices and a location of the camera device are identified, as shown in step 404. This includes, for example, using GPS data to identify the longitude and latitude coordinates of a camera device. While this process is described in terms of camera devices, any suitable electronic device may be used to implement the method 400. The step of identifying the first camera devices is to determine devices, such as IPTV devices that are available to perform processing functions for data, such as content data. The video capability, such as 3D, 1080p, closed caption etc., may also be identified.

Received data is accessed at a second camera device, as shown by step 406. Similar to the first devices, described above, the second camera devices may be any suitable electronic device, such as IPTV devices that are available to perform processing functions for data, such as content data.

Next, an interface between one or more of the first camera devices and the second camera devices is established, as shown in step 408. This interface may be used to determine processing and communication abilities of the first and second devices.

One or more of the first camera devices are then used to process data, as shown in step 410. This processing step is typically used to facilitate data processing needs of the second camera device. The first camera device(s) are used to process data for the second camera device.

The processed data is then transmitted from the first camera device(s) to the second camera device, as shown in step 420.

The processed data, processed at the first camera device is displayed at the second camera device, as shown in step 422.

The process 400 ends, as shown by end step 430.

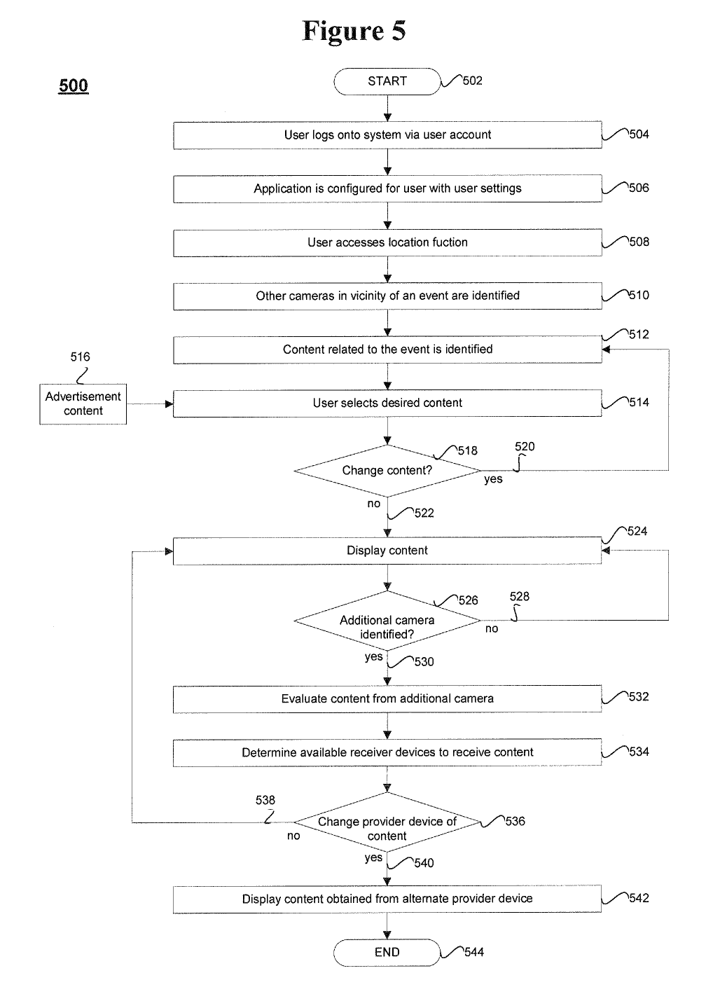

FIG. 5 shows a series of steps 500 to change a source of content, according to an embodiment of the present invention. The series of steps 500 may be stored on a non-transitory computer readable medium or media (e.g., RAM, ROM, EEPRPOM, DRAM or other memory, electronic storage device or registry) and may be executed by a processor or plurality of processors. The storage medium may be resident on the device (local) or accessed from a remote device (remote). The steps 500 are typically executed by a processor having adequate speed and processing capabilities. The execution may be at the client device and/or an associated server device. The steps 500 may be computer code or other program code (e.g., source code) that may be compiled into object code. The code, stored on a medium and/or accessed, is a module. The steps 500 may be stored on any one or more suitable modules described in relation to FIG. 1 and FIG. 2 herein.

The process 500 may be a subroutine that can be used in conjunction with the process 300 in FIG. 3, process 400 in FIG. 4, or may be executed as a stand-alone process. Also, the process 500 may be used with the modules shown in FIGS. 1 and 2. The process 500 may be executed by a processor and begins with start step 502.

A user logs onto a system, such as an IPTV system, via a user account, as shown in step 504. This may include a GPS location reporting, privacy viewing, message notification, languages and rating information.

An application is configured for a particular user with the user settings, as shown in step 506. This may include settings, available live events, pushing content to a user based on a user profile, sending a notification to a user about the content being obtained and other information.

User accesses a location function, as shown in step 508.

Other cameras, or processing devices, such as any suitable electronic device, such as IPTV devices that are available to perform processing functions for data, such as content data, that are within a predetermined distance of an event are identified, as shown in step 510. The predetermined distance is determined using longitude/latitude coordinates of the device, GPS or other suitable location technique to determine where (geographic location) a device is disposed.

Content related to the event is identified, as shown in step 512. This content may be the artist, the performance, streaming video, audio, or other data.

The user selects desired content, as shown in step 514. This user may be located remotely from the event. The available content may be indicated using an icon showing the various angles, positions of cameras providing content, etc.

The desired content that is selected may also include advertisement content, as shown in step 516. The advertisement content (516) may be audio, video, image, or other electronic content that is offering merchandise, services or other commercial transactions. The advertisement content (516) may be based on the user account, the desired content, or other criteria.

A determination is made whether or not to change the source of the content, as shown in step 518.

When the source of the content is changed, “yes” line 520 shows that the content is identified, as shown in step 512. This content that is identified may be from a different content provider, a different device, or a memory location.

When the content source is not changed, “no” line 522 shows that the content is displayed, as shown in step 524.

Additional cameras are identified, as shown in step 526. Additional cameras are cameras or electronic content obtaining devices that provide electronic content from a source to other devices, typically via a network, as described herein.

If an additional camera is not identified, “no” line 528 leads to display step 524. If an additional camera is identified, “yes” line 530 shows that the content provided from another source (camera) is evaluated, as shown in step 532.

Other available receiver devices are identified, as shown in step 534. This step includes determining whether there are other receiver devices and if so, if the devices are available to receive content.

A determination is made whether to change the source of the content, as shown in step 536. This may include changing the device that provides content to the other devices, as described herein.

If the provider source is not changed, “no” line 538 shows that the content is displayed, as shown in step 524.

If the provider device is changed, “yes” line 540 shows that the content from the alternate provider device is displayed, as shown in step 542.

The process 500 ends, as shown in step 544.

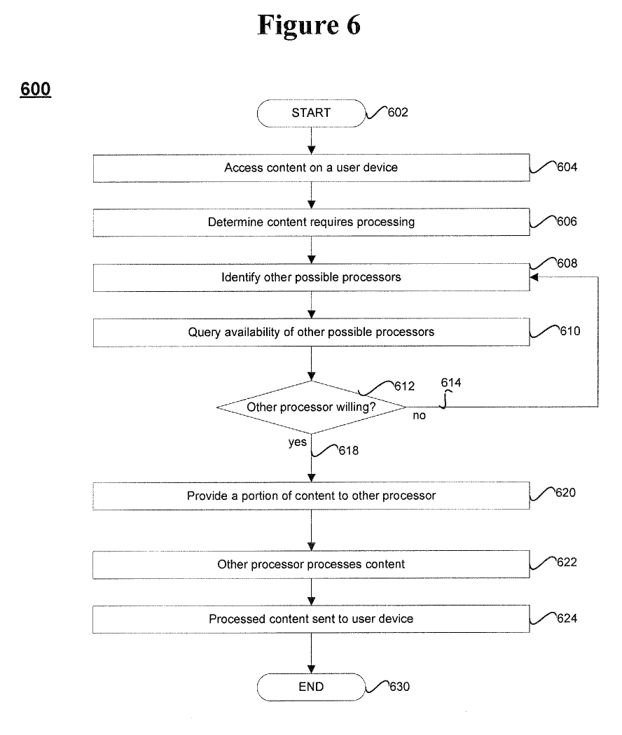

FIG. 6 shows a series of steps 600 to share processing functions between a plurality of devices. The series of steps 600 may be stored on a non-transitory computer readable medium or media (e.g., RAM, ROM, EEPRPOM, DRAM or other memory, electronic storage device or registry) and may be executed by a processor or plurality of processors. The storage medium may be resident on the device (local) or accessed from a remote device (remote). The steps 600 are typically executed by a processor having adequate speed and processing capabilities. The execution may be at the client device and/or an associated server device. The steps 600 may be computer code or other program code (e.g., source code) that may be compiled into object code. The code, stored on a medium and/or accessed, is a module. The steps 600 may be stored on any one or more suitable modules described in relation to FIG. 1 or FIG. 2 as described herein.

The process 600 may be executed by a processor and begins with start step 602.

A user accesses content on a user device, as shown in step 604. This content is audio content, image data, video content or other electronic data.

A determination is made whether the content requires additional processing, as shown in step 606. The additional processing may include filtering, and other processing operations.

A determination is made of other available processing units, as shown in step 610.

The other possible processors are sent a request, typically an API, regarding whether the processor is capable to perform processing operations, as shown in step 612. If not, “no” line 614 shows that other possible processors are identified, as shown in step 608. If the other identified processor is capable to perform processing, “yes” line 618 shows that a portion of content is provided to another processor, as shown in step 620.

The other capable processor processes the content, as shown in step 622.

The processed content is then transmitted to the user device, as shown in step 624

The process 600 ends, as shown in end step 630.

It will be appreciated from the above that the invention may be implemented as computer software, which may be supplied on a storage medium such as through a transmission medium such as a local-area network or a wide-area network, such as the Internet. It is to be further understood that, because some of the constituent system components and method steps depicted in the accompanying Figures can be implemented in software, the actual connections between the systems components (or the process steps) may differ depending upon the manner in which the present invention is programmed. Given the teachings of the present invention provided herein, one of ordinary skill in the related art will be able to contemplate these and similar implementations or configurations of the present invention.

It is to be understood that the present invention can be implemented in various forms of hardware, software, firmware, special purpose processes, or a combination thereof. In one embodiment, the present invention can be implemented in software as an application program to tangible embodied on a computer readable program storage device. The application program can be uploaded to, and executed by, a machine comprising any suitable architecture.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

What is claimed is:

1. A method for sharing content between a plurality of electronic devices comprising:
identifying an event;
detecting one or more electronic devices based on the identified event;
obtaining electronic content from the one or more of the electronic devices related to the event; and
providing electronic content to one or more output devices based on a comparison.

2. The method as claimed in claim 1, wherein the one or more output modules are located remotely from the one or more electronic devices.

3. The method as claimed in claim 1, further comprising:
utilizing a positioning system to detect that one or more electronic devices that are within a predetermined geographical distance from the event.

4. The method as claimed in claim 3, further comprising:
identifying a longitude coordinate and a latitude coordinate associated with each electronic device.

5. The method as claimed in claim 1, further comprising:
determining a perspective viewing location of an electronic device that is obtaining content.

6. The method as claimed in claim 1, wherein the electronic content is in a 3D format.

7. The method as claimed in claim 1, wherein the electronic content is in a high definition format.

8. The method as claimed in claim 1, wherein the providing step provides electronic content from the electronic devices to the output devices as a data stream.

9. The method as claimed in claim 8, further comprising storing the electronic content.

10. The method as claimed in claim 1, further comprising:
providing advertisement data as part of the electronic content.

11. The method as claimed in claim 10, further comprising:
selecting the advertisement data based on a geographical location of the electronic device receiving the advertisement data.

12. The method as claimed in claim 1, further comprising:
identifying capabilities of the detected devices.

13. The method as claimed in claim 1, further comprising:
identifying a location of one or more second electronic devices;
generating a notification related to the event; and
transmitting the notification to one or more of the second electronic devices.

14. The method as claimed in claim 1, further comprising:
modifying the obtaining step based on the comparison.

15. The method as claimed in claim 1, wherein the electronic devices that are within a predetermined geographical distance from the event are fixed cameras.

16. The method as claimed in claim 1, further comprising:
associating a user-applied tag to content.

17. The method as claimed in claim 1, further comprising:
identifying one or more available processing modules, the available processing modules being able to process electronic content;
providing electronic content to selected one or more available processing modules;
processing the electronic content at the selected one or more available processing modules; and
providing the processed electronic content to an output device.

18. The method as claimed in claim 1, further comprising:
providing a listing of electronic devices that are providing data related to an event to a user device;
receiving a selection of an electronic device from the user device; and
providing content to the user device based on the selection.

19. The method as claimed in claim 18, wherein the listing of electronic devices includes functionality of each listed electronic device.

20. The method as claimed in claim 1, wherein the electronic devices include cameras.

21. The method as claimed in claim 1, further comprising:
restricting electronic content provided by one of the electronic devices based on a user of the electronic device refusing to provide electronic content to an output device.

22. The method as claimed in claim 1, further comprising:
providing a listing of electronic devices that are providing data related to an event to a user device;
receiving a selection of a media format from the user device; and
providing content to the user device based on the selection.

23. The method as claimed in claim 22, further comprising:
providing a plurality of content to the user device in a plurality of formats simultaneously.

24. The method as claimed in claim 1, wherein the electronic devices include audio output devices.

25. The method as claimed in claim 1, wherein the electronic content is text content.

26. The method as claimed in claim 25 wherein the electronic content includes video content, and/or image content and/or audio content.

27. The method as claimed in claim 1, wherein the step of identifying an event further comprises:
identifying a plurality of events within a predefined geographical region;
organizing the plurality of events within the predefined geographical region into one or more clusters; and
labeling the one or more clusters.

28. The method as claimed in claim 1, wherein the step of identifying an event further comprises:
identifying a plurality of events within a predefined time period;
organizing the plurality of events within the predefined time period into one or more clusters; and
labeling the one or more clusters.
